(19) United States
(12) Patent Application Publication
(10) Pub. No.: US 2025/0371643 A1
(43) Pub. Date: Dec. 4, 2025

(54) Software Application for Pet Transportation Device

(71) Applicant: Christina Canales, Glen Burnie, MD (US)

(72) Inventor: Christina Canales, Glen Burnie, MD (US)

(21) Appl. No.: 19/226,278

(22) Filed: Jun. 3, 2025

Related U.S. Application Data
(60) Provisional application No. 63/655,788, filed on Jun. 4, 2024.

(51) Int. Cl. G06Q 50/47; A01K 11/00; G06Q 10/02; G06Q 30/0601

(52) U.S. Cl. CPC G06Q 50/47; A01K 11/008; G06Q 10/02; G06Q 30/0603

(57) ABSTRACT

A pet transportation application device is disclosed, which is a unique software application accessible on a smartphone, tablet, laptop, or a desktop computer. Specifically, the device is a rideshare application designed to safely transport dogs or other animals when their owners aren't free to take them where they need to go. The application has an easy-to-use interface which makes it simple to arrange rides, short-term pet sitting, dog walking, and other services in a one-stop shop. The software application is ideal for non-drivers, including elderly or disabled individuals. The application provides monthly or yearly membership options, plus reward and discount tires.

### CROSS-REFERENCE TO RELATED APPLICATION

The present application claims priority to, and the benefit of, U.S. Provisional Application No. 63/655,788, which was filed on Jun. 4, 2024, and is incorporated herein by reference in its entirety.

### FIELD OF THE INVENTION

The present invention relates generally to the field of pet transportation application devices. More specifically, the present invention relates to a software application to schedule safe transportation for a pet. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in pet transportation application devices. Generally, current applications to obtain transportation are for individuals and not pets. Often, pets need transportation to various locations (i.e., vet, day care, etc.) with or without a companion.

Accordingly, users may have the need to transport their pets and desires to arrange independent travel for the pet to such things as vet appointments, park visits, pet playdates, doggy daycare, etc. Sometimes pet owners don't have the time to drive their pets around and sometimes the pet places have limited hours. Thus, a need exists for a ride share service that transports pets without the owner needing to ride along.

Therefore, there exists a long-felt need in the art for a pet transportation application device that provides users with a software application to schedule transportation for a pet. There is also a long-felt need in the art for a pet transportation application device that allows pet owners to schedule additional services which may be needed to care for the pet. Further, there is a long-felt need in the art for a pet transportation application device that provides a rideshare app designed to safely transport dogs or other animals. Moreover, there is a long-felt need in the art for a device that utilizes an easy-to-use interface which makes it simple to arrange rides for the pets. Further, there is a long-felt need in the art for a pet transportation application device that can have monthly or yearly membership options. Finally, there is a long-felt need in the art for a pet transportation application device that allows a portion of the proceeds to be donated to animal welfare causes and rescue organizations.

The subject matter disclosed and claimed herein, in one embodiment thereof, comprises a pet transportation application device. The device is a unique software application accessible on a smartphone, tablet, laptop, or a desktop computer. Specifically, the device is a rideshare application designed to safely transport dogs or other animals when their owners aren't free to take them where they need to go. The application has an easy-to-use interface which makes it simple to arrange rides, short-term pet sitting, dog walking, and other services in a one-stop shop. The software application is ideal for non-drivers, including elderly or disabled individuals. The application provides monthly or yearly membership options, plus reward and discount tires.

In this manner, the pet transportation application device of the present invention accomplishes all of the forgoing objectives and provides users with a ride share app for pets. The device is a software application that has the potential to expand to larger animals, including livestock. The device finds transport and pet care.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pet transportation application device. The device is a unique software application accessible on a smartphone, tablet, laptop, or a desktop computer. Specifically, the device is a rideshare application designed to safely transport dogs or other animals when their owners aren't free to take them where they need to go. The application has an easy-to-use interface which makes it simple to arrange rides, short-term pet sitting, dog walking, and other services in a one-stop shop. The software application is ideal for non-drivers, including elderly or disabled individuals. The application provides monthly or yearly membership options, plus reward and discount tiers.

In one embodiment, the pet transportation application device utilizes a smartphone, a tablet, a laptop or a desktop computer, etc., or any other suitable electronic device that has the required operating and memory parameters to support the software application of the present invention.

In one embodiment, the pet transportation application device utilizes a mobile computing device (i.e., smart phone, computer, tablet, etc.) comprising a software application which is a full-service pet app app, that includes rideshare, designed to safely transport dogs or other animals when their owners are unavailable. The mobile or software application provides a secure website and/or smart phone app access by users for arranging pet rides and other services for their pets, with or without a companion. In addition to these elements, the device of the present invention may also include: a web server and Cloud database of location and rideshare data connectable to the mobile smartphone or portable tablet or computer device.

In one embodiment of the invention, the location and rideshare data and data management software are maintained on a Microsoft Cloud server in a typical fashion, or other cloud server, such as the Adobe, Apple or Amazon cloud server, etc. A secure cloud server is used for the protection and security of the rideshare data, and other needed information data stored on the cloud server for the other pet services. Thus, the rideshare data and data management is sent to the cloud server and collected. Conveniently, the data is stored and managed with a data management software or program to manage the collected rideshare data and location data.

Typically, a cellular wireless data network embedded in the computer, tablet or smartphone, etc., transmits both rideshare data and available drivers at requested times to a user. Such rideshare and location data can be processed by a Cloud data management server. Further, on the smart device, a digital mapping service, such as Microsoft Bing mapping or other competitive mapping services determines the potential drivers of the rideshare app locations and allows for visual tracking of the drivers in real-time. Thus, at any given time, the location of the drivers can be determined.

Further, the software application can include GPS services. The Global Positioning System (GPS) is a satellite-based navigation system made up of a network of 24 satellites placed into orbit by the U.S. Department of Defense. GPS was originally intended for military applications, but in the 1980s, the government made the system available for civilian use. The GPS system is embedded in many computers, tablets and smartphones, etc., and is used in navigation applications in these devices as well as vehicles and hunter or outdoor tracking devices.

Mobility is a key feature of the present invention. It permits flexibility. For example, if a user requests a ride and/or a service for their pet, the user can track the requested ride or performance of a service in real time, by identifying its immediate location on a digital map. Thus, a user would know when exactly the pet would be picked up and/or dropped off or when the selected service is performed.

The present invention offers a solution to transporting pets back and forth from various activities and/or performing various services, when the user/pet owner is working or otherwise unavailable to transport the pet and/or perform the service. The software application provides a rideshare app and a variety of services that safely allow a user to transport their pet with or without a companion. The software application functions as a traditional rideshare app and tracks available drivers and gives real-time location of available drivers, as well as the location of drivers enroute with a specific pet. Specifically, GPS coordinates and digital mapping services are used to locate and track drivers and display their locations in real-time via the smartphone, computer, or tablet, etc. Further, optional text message notifications can be utilized to notify users and/or pet owners of their pet being picked up and dropped off and/or the selected service being performed.

In one embodiment, the software application allows a user to arrange transportation to multiple venues for a pet, with or without a companion. For example, the software application allows a user to arrange independent transportation to vet appointments, park visits, pet playdates, doggy daycare, etc.

In one embodiment, the software application comprises an easy-to-use user interface which makes it simple for users to arrange rides for their pets with or without a companion. The software application is ideal for non-drivers, including the elderly or disabled individuals, as well as for users/pet owners who work and/or have limited time to transport their pets.

In one embodiment, the user downloads the software application to their smart phone or other electronic device. When accessing the software application, the user first reaches the home screen and is asked to input a username and password to log-in to the software application. Users can enter into a monthly or yearly membership account, which can include various reward and discount tiers. In another embodiment, a portion of the proceeds can go to animal welfare causes, and/or to support rescue organizations and other pet-related charities.

In one embodiment, after logging-in to the software application, the user enters the home screen. The home screen would list the various functions that are available for the user to arrange. For example, users can input their home address, as well as the address they need the pet dropped off at. There could also be a listing of ways to donate to various pet-related charities. Further, there would be a services area, which when a user accesses that area, the user is sent to the services screen.

In one embodiment, after selecting the service area, the user enters the services screen which displays the various services available for a user and their pet. The various services can include taxi services, dog walking, pet sitting, dog training, animal behavior therapy and animal merchandise to be purchased, etc. Accordingly, users can arrange for any number of services available and can schedule future rides, services, etc. In one embodiment, the user can quickly find pet care during emergency situations, including sudden hospitalizations, and/or accidents.

In one embodiment, after selecting the various services, the user is then sent to a screen where the user can view the available rides and their corresponding costs. This screen can display different levels of rides, such as economy or premium, or different sizes of rides for multiple animals and/or extra-large animals. In one embodiment, alternative transit modes can be displayed, such as private planes and boats, etc., for animals with unique travel needs. Furthermore, the software application can also be used with larger animals, such as livestock or exotic/zoo animals, etc. Further, the software application offers a platform for businesses and services to connect with new users.

In one embodiment, the software application also allows a user to schedule and obtain additional services for their pet, such as short-term pet sitting, dog walking, pet grooming, backyard poop scooping, etc. These add-on services can be added-on to the original taxi service or multiple add-on services can be added together, etc. If a user chooses the add-on section, they are sent to a screen where the add-on services are listed for them to choose from. Once all services are selected, a user taps the pay button to complete the transaction and schedule the services selected.

In yet another embodiment, the pet transportation application device comprises a plurality of indicia.

In yet another embodiment, a method of safely transporting animals without their owners using a software application is disclosed. The method includes the steps of providing a pet transportation application device comprising a software application that provides a rideshare app for pet owners. The method also comprises accessing the software application. Further, the method comprises utilizing an easy-to-use interface for arranging pet transportation without an owner. Finally, the method comprises arranging independent transportation to vet appointments, park visits, pet playdates, or doggy daycare on the application.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the pet transportation application device of the present invention showing the login screen in accordance with the disclosed architecture;

FIG. 2 illustrates a perspective view of one embodiment of the pet transportation application device of the present invention showing the home screen in accordance with the disclosed architecture;

FIG. 3 illustrates a perspective view of one embodiment of the pet transportation application device of the present invention showing the services offered in accordance with the disclosed architecture;

FIG. 4 illustrates a perspective view of one embodiment of the pet transportation application device of the present invention showing the taxi portion of the app in accordance with the disclosed architecture;

FIG. 5 illustrates a perspective view of one embodiment of the pet transportation application device of the present invention showing how the device can add additional add-ons to the taxi services in accordance with the disclosed architecture;

FIGS. 6A-C illustrate a perspective view of one embodiment of the pet transportation application device of the present invention showing the easy-to-use interface for the device in accordance with the disclosed architecture;

FIG. 7 illustrates a flowchart showing the method of safely transporting animals without their owners using a software application in accordance with the disclosed architecture;

FIG. 8 is a schematic diagram illustrating one embodiment of the pet transportation application device of the present invention in accordance with the disclosed architecture; and

FIG. 9 illustrates an exemplary user device that is used for installing the pet transportation application device of the present invention for communication with a server system in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a pet transportation application device that provides users with a software application to schedule transportation for a pet. There is also a long-felt need in the art for a pet transportation application device that allows pet owners to schedule additional services which may be needed to care for the pet. Further, there is a long-felt need in the art for a pet transportation application device that provides a rideshare app designed to safely transport dogs or other animals. Moreover, there is a long-felt need in the art for a device that utilizes an easy-to-use interface which makes it simple to arrange rides for the pets. Further, there is a long-felt need in the art for a pet transportation application device that can have monthly or yearly membership options. Finally, there is a long-felt need in the art for a pet transportation application device that allows a portion of the proceeds to be donated to animal welfare causes and rescue organizations.

The present invention, in one exemplary embodiment, is a novel pet transportation application device. The device is a unique software application accessible on a smartphone, tablet, laptop, or a desktop computer. Specifically, the device is a rideshare application designed to safely transport dogs or other animals when their owners aren't free to take them where they need to go. The application has an easy-to-use interface which makes it simple to arrange rides, short-term pet sitting, dog walking, and other services in a one-stop shop. The software application is ideal for non-drivers, including elderly or disabled individuals. The application provides monthly or yearly membership options, plus reward and discount tires. The present invention also includes a novel method of safely transporting animals without their owners using a software application. The method includes the steps of providing a pet transportation application device comprising a software application that provides a rideshare app for pet owners. The method also comprises accessing the software application. Further, the method comprises utilizing an easy-to-use interface for arranging pet transportation without an owner. Finally, the method comprises arranging independent transportation to vet appointments, park visits, pet playdates, or doggy daycare on the application.

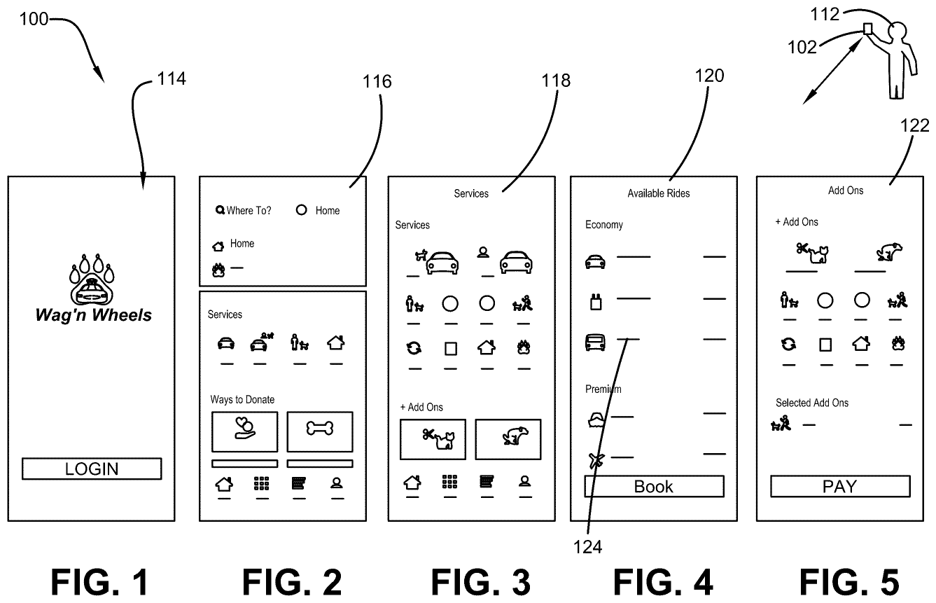

Referring initially to the drawings, FIGS. 1-5 illustrate a perspective view of one embodiment of the pet transportation application device 100 of the present invention. In the present embodiment, the pet transportation application device 100 is a software application that allows pet owners/users 112 to safely transport dogs or other animals when their owners 112 aren't free to take them where they need to go. Specifically, the pet transportation application device 100 is a unique software application accessible on a smartphone 102, tablet, laptop, or a desktop computer (i.e., user device 102). Users 112 utilize an easy-to-use interface 114 to arrange rides and other services in a one-stop shop.

Typically, the pet transportation application device 100 utilizes a smartphone 102, a tablet, a laptop or a desktop computer, etc., or any other suitable electronic device that has the required operating and memory parameters to support the software application 100 of the present invention.

Further, the pet transportation application device 100 utilizes a mobile computing device 102 (i.e., smart phone, computer, tablet, etc.) comprising a software application 100 which is a rideshare app designed to safely transport dogs or other animals when their owners are unavailable. The mobile or software application 100 provides a secure website and/or smart phone app access by users 112 for arranging pet rides and other services for their pets, with or without a companion. In addition to these elements, the device 100 of the present invention may also include: a web server and Cloud database of location and rideshare data connectable to the mobile smartphone 102 or portable tablet or computer device.

Additionally, the location and rideshare data and data management software are maintained on a Microsoft Cloud server in a typical fashion, or other cloud server, such as the Adobe, Apple or Amazon cloud server, etc. A secure cloud server is used for the protection and security of the rideshare data, and other needed information data stored on the cloud server for the other pet services. Thus, the rideshare data and data management is sent to the cloud server and collected. Conveniently, the data is stored and managed with a data management software or program to manage the collected rideshare data and location data.

Typically, a cellular wireless data network 106 embedded in the computer, tablet or smartphone 102, etc., transmits both rideshare data and available drivers at requested times to a user 112. Such rideshare and location data can be processed by a Cloud data management server. Further, on the smart device 102, a digital mapping service, such as Microsoft Bing mapping or other competitive mapping services determines the potential drivers of the rideshare app locations and allows for visual tracking of the drivers in real-time. Thus, at any given time, the location of the drivers can be determined.

Further, the software application 100 can include GPS services. The Global Positioning System (GPS) is a satellite-based navigation system made up of a network of 24 satellites placed into orbit by the U.S. Department of Defense. GPS was originally intended for military applications, but in the 1980s, the government made the system available for civilian use. The GPS system is embedded in many computers, tablets and smartphones, etc., and is used in navigation applications in these devices as well as vehicles and hunter or outdoor tracking devices.

Mobility is a key feature of the present invention. It permits flexibility. For example, if a user 112 requests a ride and/or a service for their pet, the user 112 can track the requested ride or performance of a service in real time, by identifying its immediate location on a digital map. Thus, a user 112 would know when exactly the pet would be picked up and/or dropped off or when the selected service is performed.

The present invention offers a solution to transporting pets back and forth from various activities and/or performing various services, when the user/pet owner 112 is working or otherwise unavailable to transport the pet and/or perform the service. The software application 100 provides a rideshare app and a variety of services that safely allow a user 112 to transport their pet with or without a companion. The software application 100 functions as a traditional rideshare app and tracks available drivers and gives real-time location of available drivers, as well as the location of drivers enroute with a specific pet. Specifically, GPS coordinates and digital mapping services are used to locate and track drivers and display their locations in real-time via the smartphone 102, computer, or tablet, etc. Further, optional text message notifications can be utilized to notify users 112 and/or pet owners of their pet being picked up and dropped off and/or the selected service being performed.

Further, the software application 100 allows a user 112 to arrange transportation to multiple venues for a pet, with or without a companion. For example, the software application 100 allows a user 112 to arrange independent transportation to vet appointments, park visits, pet playdates, doggy daycare, etc.

Additionally, the software application 100 comprises an easy-to-use user interface 114 which makes it simple for users 112 to arrange rides for their pets with or without a companion. The software application 100 is ideal for non-drivers, including the elderly or disabled individuals, as well as for users/pet owners 112 who work and/or have limited time to transport their pets.

As shown in FIG. 1, the user 112 downloads the software application 100 to their smart phone 102 or another electronic device. When accessing the software application 100, the user 112 first reaches the home screen 116 and is asked to input a username and password to log-in to the software application 100. Users 112 can enter into a monthly or yearly membership account, which can include various reward and discount tiers. In another embodiment, a portion of the proceeds can go to animal welfare causes, and/or to support rescue organizations and other pet-related charities.

As shown in FIG. 2, after logging-in to the software application 100, the user 112 enters the home screen 116. The home screen 116 would list the various functions that are available for the user 112 to arrange. For example, users 112 can input their home address, as well as the address they need the pet dropped off at. There could also be a listing of ways to donate to various pet-related charities. Further, there would be a services area 118, which when a user 112 accesses that area, the user 112 is sent to the services screen 118.

As shown in FIG. 3, after selecting the service area 118, the user 112 enters the services screen 118 which displays the various services available for a user 112 and their pet. The various services can include taxi services, dog walking, pet sitting, dog training, animal behavior therapy and animal merchandise to be purchased, etc. Accordingly, users 112 can arrange for any number of services available and can schedule future rides, services, etc. In one embodiment, the user 112 can quickly find pet care during emergency situations, including sudden hospitalizations, and/or accidents.

As shown in FIG. 4, after selecting the various services, the user 112 is then sent to a screen 120 where the user 112 can view the available rides and their corresponding costs. This screen 120 can display different levels of rides, such as economy or premium, or different sizes of rides for multiple animals and/or extra-large animals. In one embodiment, alternative transit modes can be displayed, such as private planes and boats, etc., for animals with unique travel needs. Furthermore, the software application 100 can also be used with larger animals, such as livestock or exotic/zoo animals, etc. Further, the software application 100 offers a platform for businesses and services to connect with new users 112.

As shown in FIG. 5, the software application 100 also allows a user 112 to schedule and obtain additional services for their pet, such as short-term pet sitting, dog walking, pet grooming, backyard poop scooping, etc. These add-on services can be added-on to the original taxi service or multiple add-on services can be added together, etc. If a user 112 chooses the add-on section 122, they are sent to a screen where the add-on services are listed for them to choose from. Once all services are selected, a user 112 taps the pay button to complete the transaction and schedule the services selected.

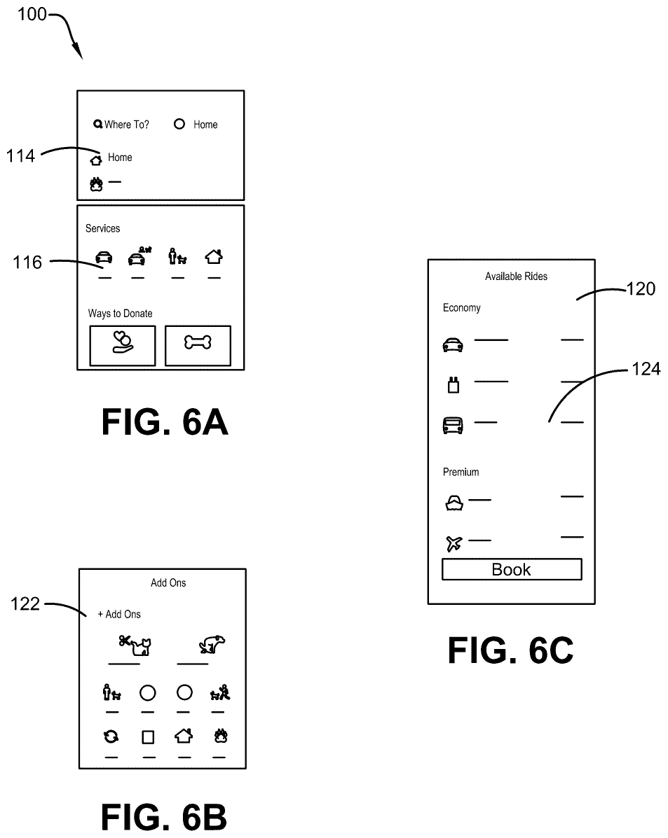

As shown in FIGS. 6A-C, the pet transportation application device 100 comprises a plurality of indicia 124. The smart device 102 of the device 100 may include advertising, a trademark, or other letters, designs, or characters, printed, painted, stamped, or integrated into the smart device 102, or any other indicia 124 as is known in the art. Specifically, any suitable indicia 124 as is known in the art can be included, such as but not limited to, patterns, logos, emblems, images, symbols, designs, letters, words, characters, animals, advertisements, brands, etc., that may or may not be pet, rideshare, or brand related.

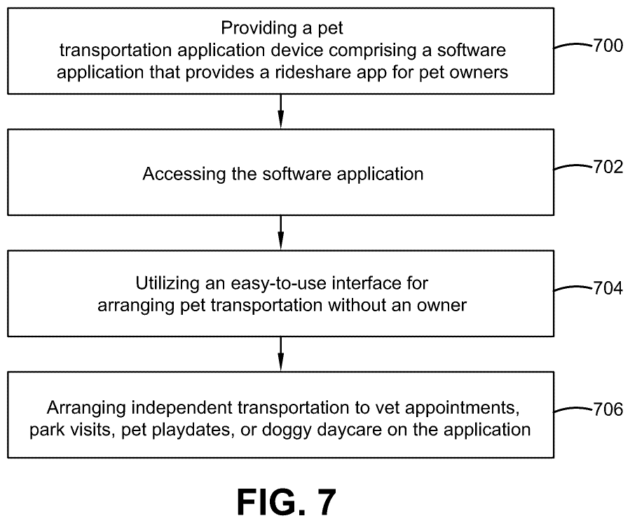

FIG. 7 illustrates a flowchart of the method of safely transporting animals without their owners using a software application. The method includes the steps of at 700, providing a pet transportation application device comprising a software application that provides a rideshare app for pet owners. The method also comprises at 702, accessing the software application. Further, the method comprises at 704, utilizing an easy-to-use interface for arranging pet transportation without an owner. Finally, the method comprises at 706, arranging independent transportation to vet appointments, park visits, pet playdates, or doggy daycare on the application.

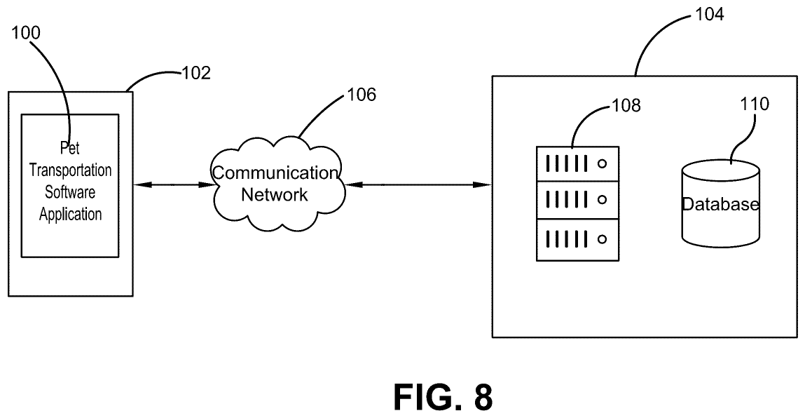

FIG. 8 is a schematic diagram illustrating one embodiment of the pet transportation software application 100 of the present invention. The application 100 has a client-server architecture wherein a user accesses the application 100 installed on a user device 102. The application 100 also comprises a server system 104 and the user device 102 is communicatively coupled to the server system 104 via a communication network 106, such as the Internet. The user device 102 is capable of facilitating a user to input data, receive data, and/or transmit data within the application 100. It will be apparent to a user of ordinary skill in the art that the user may be any personnel using the application 100, without deviating from the scope of the disclosure. Examples of the user device 102 may include, but are not limited to, a desktop, a notebook, a laptop, a handheld computer, a touch sensitive device, a tablet, a computing device, a smart-phone, and/or a smart watch, etc., or any other suitable device as is known in the art.

The server system 104 is a network of computers, a software framework, or a combination thereof, that may provide a generalized approach to creating the server implementation. More specifically, the server system 104 includes an application server 108 and one or more associated databases 110. The application server 108 and the databases 110 can be integrated as a single unit or can be coupled to each other through a network. Examples of the application server 108 may include, but are not limited to, personal computers, laptops, mini-computers, mainframe computers, any non-transient and tangible machine that can execute a machine-readable code, cloud-based servers, distributed server networks, or a network of computer systems, etc. The application server 108 can be realized through various web-based technologies such as, but not limited to, a Java web-framework, a .NET framework, a personal home page (PHP) framework, or any web-application framework, etc. The server system 104 can be maintained by a storage facility management authority or a third-party entity that facilitates service enablement and resource allocation operations of the application 100.

The application server 108 is configured to have the logic, instructions, circuitry, interfaces, and/or codes for executing various operations required for communication between the server 108 and the user device 102 and also between the databases 110 and the server 108. The databases 110 are configured to store therein, data associated with users' account information from the application 100, as well as bus identification and locations, and route histories. In some embodiments, a set of centralized or distributed network of peripheral memory devices may be interfaced with the server 104, as an example, on a cloud server.

The communication network 106 may include suitable logic, circuitry, and interfaces that may be configured to provide a plurality of network ports and a plurality of communication channels for transmission and reception of data related to operations of various entities (such as the user device 102 and the server system 104) of the application 100. Each network port may correspond to a virtual address (or a physical machine address) for transmission and reception of the communication data. For example, the virtual address may be an Internet Protocol Version 4 (IPV4) (or an IPV6 address) and the physical address may be a Media Access Control (MAC) address. The communication network 106 may be associated with an application layer for implementation of communication protocols based on one or more communication requests from the user device 102 and the server system 104. The communication data may be transmitted or received, via the communication protocols. Examples of the communication protocols may include, but are not limited to, Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), Long Term Evolution (LTE) communication protocols, or any combination thereof.

In one embodiment, the communication data may be transmitted or received via at least one communication channel or a plurality of communication channels in the communication network 106. The communication channels may include, but are not limited to, a wireless channel, a wired channel, a combination of wireless and wired channel thereof. The wireless or wired channel may be associated with a data standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a metropolitan area network (MAN), a satellite network, the Internet, a fiber optic network, a coaxial cable network, an infrared (IR) network, a radio frequency (RF) network, and a combination thereof. Embodiments of the present invention are intended to include or otherwise cover any type of communication channel, including known, related art, and/or later developed technologies.

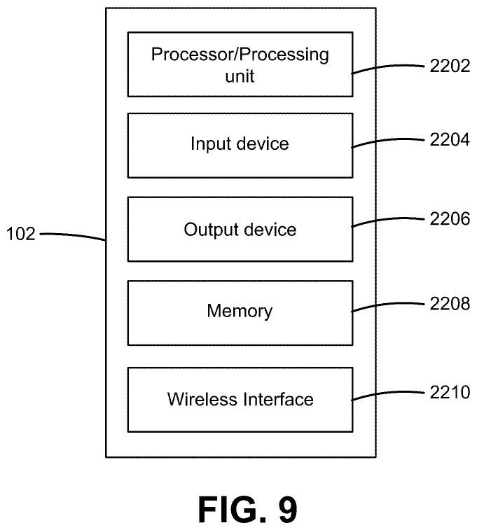

FIG. 9 illustrates an exemplary user device 102 that is used for installing the software application 100 of the present invention. The processing unit 2202 may include suitable logic, instructions, circuitry, interfaces, and/or codes for executing various operations, such as the operations associated with the user device 102, etc. The processing unit 2202 may be configured to control one or more operations executed by the user device 102 in response to the input received at the user device 102 from the user. The processor 2202 executes the computer readable instructions stored in the software application. Examples of the processing unit 2202 may include, but are not limited to, an application-specific integrated circuit (ASIC) processor, a reduced instruction set computing (RISC) processor, a complex instruction set computing (CISC) processor, a field-programmable gate array (FPGA), a Programmable Logic Control unit (PLC), etc. Embodiments of the present disclosure are intended to include or otherwise cover any type of processing unit 2202 including known, related art, and/or later developed processing units. The user device 102 can further include one or more computer executable applications configured to be executed by the processing unit 2202. The one or more computer executable applications may include suitable logic, instructions, and/or codes for executing various operations. The one or more computer executable applications may be stored in the memory 2208. The one or more computer executable applications includes the software application 100.

The user device 102 comprises input device(s) 2204, such as a touch input device, a voice input device, etc., for entering data and information. Preferably, the touch interface of the user device 102 is used as the input and various buttons/tabs shown on the software application are pressed or clicked by the user.

Electronic device 102 also comprises a memory 2208 used for storing programs (sequences of instructions) or data (i.e., program state information) on a temporary or permanent basis for use in the computer system. Memory 2208 can be configured for short-term storage of information as volatile memory and therefore not retain stored contents if powered off. Examples of volatile memories include random access memories (RAM), dynamic random-access memories (DRAM), static random-access memories (SRAM), and other forms of volatile memories known in the art. The processor 2202, in combination with one or more of memory 2208, input device(s) 2204, and output device(s) 2206 is utilized to allow users to execute instructions on the application 100. The connection to a network is provided by wireless interface 2210.

The wireless interface 2210 enables the user device 102 to communicate with the server 104 and other components of the application 100 over the communication network 106, according to embodiments of the present disclosure. Examples of the communication interface 2210 may include, but are not limited to, a modem, a network interface such as an Ethernet card, a communication port, and/or a Personal Computer Memory Card International Association (PCMCIA) slot and card, an antenna, a radio frequency (RF) transceiver, one or more amplifiers, a tuner, one or more oscillators, a digital signal processor, a coder-decoder (CODEC) chipset, a subscriber identity module (SIM) card, and a local buffer circuit, etc. It will be apparent to a user of ordinary skill in the art that the communication interface 2210 may include any device and/or apparatus capable of providing wireless or wired communications between the user device 102 and the server 104.

Embodiments of the present disclosure take the form of computer-executable instructions, including algorithms executed by a programmable computer. However, the disclosure can be practiced with other computer system configurations as well. Certain aspects of the disclosure can be embodied in a special-purpose computer or data processor that is specifically programmed, configured, or constructed to perform one or more of the computer-executable algorithms described below. Accordingly, the term “computer” as generally used herein refers to any data processor and includes Internet appliances, hand-held devices (including tablets, computers, wearable computers, cellular or mobile phones, multi-processor systems, processor-based or programmable consumer electronics, network computers, minicomputers) and the like.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “pet transportation application device”, “pet transportation device”, “software application device”, and “device” are interchangeable and refer to the pet transportation application device 100 of the present invention.

Notwithstanding the forgoing, the pet transportation application device 100 of the present invention can be of any suitable size and configuration as is known in the art without affecting the overall concept of the invention, provided that it accomplishes the above stated objectives. One of ordinary skill in the art will appreciate that the pet transportation application device 100 as shown in FIGS. 1-9 is for illustrative purposes only, and that many other sizes and shapes of the pet transportation application device 100 are well within the scope of the present disclosure. Although the dimensions of the pet transportation application device 100 are important design parameters for user convenience, the pet transportation application device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pet transportation application device that allows for the safe transport of pets, the pet transportation application device comprising:
a software application; and
a user interface;
wherein the software application is accessible on a smart device; and
further wherein the user interface allows a user to schedule various services for their pet with or without a companion.

2. The pet transportation application device of claim 1, wherein the smart device is a smartphone, tablet, laptop, or a desktop computer.

3. The pet transportation application device of claim 2, wherein the software application is a rideshare app designed to safely transport pets when their owners are unavailable.

4. The pet transportation application device of claim 3, wherein the software application provides a secure website or smart phone app access by users for arranging pet rides and other services for their pets, with or without a companion.

5. The pet transportation application device of claim 4 further comprising a web server and Cloud database of location and rideshare data connectable to the smart device.

6. The pet transportation application device of claim 5, wherein the software application utilizes a digital mapping service.

7. The pet transportation application device of claim 6, wherein the software application utilizes GPS services.

8. The pet transportation application device of claim 7, wherein the software application allows a user to arrange transportation to multiple venues for a pet, with or without a companion, such as vet appointments, park visits, pet playdates, or doggy daycare.

9. The pet transportation application device of claim 8, wherein a user downloads the software application to their smart device and access the user interface to log into a home screen.

10. The pet transportation application device of claim 9, wherein users can enter into a monthly or yearly membership account.

11. The pet transportation application device of claim 10, wherein users select a services screen on the user interface and choose specific pet services.

12. The pet transportation application device of claim 11 wherein the variety of services can include taxi services, dog walking, pet sitting dog training, animal behavior therapy or animal merchandise to be purchased.

13. A pet transportation application device that allows for the safe transport of pets, the pet transportation application device comprising:
a software application which is a rideshare app designed to safely transport pets when their owners are unavailable; and
a user interface;
wherein the software application provides a secure website or smart phone app access by users for arranging pet rides and other services for their pets, with or without a companion;
wherein the software application utilizes a digital mapping service and GPS services;
wherein the user interface allows a user to schedule various services for their pet with or without a companion;
wherein a user downloads the software application to their smart device and access the user interface to log into a home screen;
wherein users select a services screen on the user interface and choose specific pet services; and
further wherein the variety of services can include taxi services, dog walking, or pet sitting.

14. The pet transportation application device of claim 13, wherein alternative transit modes can be displayed, such as private planes and boats.

15. The pet transportation application device of claim 13, wherein larger animals, such as livestock or exotic animals can be serviced on the software application.

16. The pet transportation application device of claim 13, wherein add-on services can be utilized on the software application in addition to rideshare or taxi services.

17. The pet transportation application device of claim 16, wherein the add-on services include short-term pet sitting, dog walking, pet grooming, or backyard poop scooping.

18. The pet transportation application device of claim 13 further comprising a plurality of indicia.

19. The pet transportation application device of claim 13, wherein a user can elect to donate to animal welfare causes or other pet-related charities.

20. A method of safely transporting animals without their owners using a software application, the method comprising the following steps:
providing a pet transportation application device comprising a software application that provides a rideshare app for pet owners;
accessing the software application;
utilizing an easy-to-use interface for arranging pet transportation without an owner; and arranging independent transportation to vet appointments, park visits, pet playdates, or doggy daycare on the application.
